(19) United States
(12) Patent Application Publication
(10) Pub. No.: US 2004/0163496 A1
(43) Pub. Date: Aug. 26, 2004

(54) Setting tool for adhesively bonded threaded rod anchors

(76) Inventor: Mark S. Timmerman, Elgin, IL (US)

Correspondence Address: Lisa M. Soltis, Illinois Tool Works Inc., 3600 West Lake Avenue, Glenview, IL, 60025, US

(21) Appl. No.: 10/374,233

(22) Filed: Feb. 25, 2003

(51) Int. Cl. B25B 13/50

(52) U.S. Cl. 81/53.2

(57) ABSTRACT

A setting tool for facilitating the insertion of threaded rod anchors within a substrate or foundation comprises a substantially cup-shaped housing having an internally threaded bore for threadedly receiving and mating with an threaded rod anchor. A button member extends axially inwardly from an internal end portion of the cup-shaped housing and comprises a planar engagement surface for engaging the free end portion of the threaded rod anchor in a non-destructive manner, wherein the free end portion of the threaded rod anchor may have a planar or non-planar surface. An annular notch is also defined within an outer peripheral surface portion of the housing so as to define a line of frangibility along which the cup-shaped housing can be separated into a residual portion, which may be discarded after the threaded rod anchor is fixed within the foundation or substrate, and a nut member which remains threaded upon the threaded rod anchor for securing auxiliary components to the substrate or foundation.

### FIELD OF THE INVENTION

The present invention relates generally to tools, and more particularly to a new and improved setting tool which is especially adapted for use in connection with the insertion and fixation of threaded rods within, for example, blind bores formed within concrete, masonry, rock, and similar substrates or underlying substructures, wherein a suitable adhesive or other similar bonding material is disposed within the blind bores for fixedly securing the threaded rods therewithin when the adhesive bonding material cures and sets.

### BACKGROUND OF THE INVENTION

Threaded rods, studs, or anchors are extensively utilized within, for example, the construction industry in order to mount various components upon concrete, masonry, rock, and similar substrates or underlying foundations. Normally, the substrate or underlying foundation is provided with a blind bore within which the threaded rod, stud, or anchor is to be fixedly secured by means of, for example, a suitable adhesive bonding material upon curing and setting of the same. One exemplary threaded stud or anchor system is disclosed within U.S. Pat. No. 4,404,875 which issued to Sadanandan et al. on Sep. 20, 1983. As disclosed within FIG. 1, which substantially corresponds to FIG. 1 of the noted patent, a blind bore 10 has been drilled within a concrete, masonry, rock, or similar foundation 14, and in order to fixedly secure a threaded stud 5 within the drilled bore 10, a capsule or ampule 8 containing adhesive resin materials is disposed within the bottom of the bore or hole 10. A drive unit 1 comprises an upper end portion 3 which is adapted to be mounted within a chuck mechanism 12 of a rotary drill, not shown, and a lower end portion 4 which is externally threaded in a manner similar to that of the threaded stud 5. An internally threaded nut member 6 is adapted to join the lower externally threaded end portion 4 of the drive unit 1 to the upper end portion of the threaded stud 5 as a result of the convexly shaped end portion 11 of the drive unit 1 being disposed in abutment with the upper planar end portion of the threaded stud 5.

When the threaded stud 5 is to be fixedly secured within the bore or hole 10 of the foundation or substrate 14, the lower chamfered or tapered end portion 7 of the threaded stud 5 is forced downwardly against the capsule or ampule 8 so as to fracture the same, and upon actuation of the drill tool, not shown, the threaded stud 5 is driven downwardly to the bottom end portion of the bore or hole 10 so as to not only be seated within the lowermost depth portion thereof but to also agitate and fully mix the adhesive resin materials or components together. When the threaded stud 5 is fully seated within the lowermost depth region of the bore or hole 10, operation of the drill tool is terminated, and a pair of wrenches are respectively applied to the nut member 6 and the intermediate hexagonally-configured portion 2 of the drive unit 1. Upon rotation of such members 6,2 in the opposite directions, the drive unit 1 is separated from the nut member 6 and the threaded stud 5. When the adhesive bonding materials cure and set, the threaded stud 5 is fixedly secured within the foundation 14 so as to permit various components or devices to be mounted thereon or attached thereto. While the aforenoted patented system or assembly is operatively viable, it is apparent that in order to release the drive unit 1 from the threaded stud 5 which is mounted within the foundation 14, the disengagement operation or procedure is relatively time-consuming due to the need for utilizing a pair of wrenches, and in addition, in light of the fact that a pair of wrenches are required to be used, additional tools need to be carried or utilized by the operator personnel.

Accordingly, a threaded stud or anchor system, which was developed so as to effectively overcome the various operational disadvantages or drawbacks characteristic of the anchor system disclosed within the aforenoted patent to Sadanandan et al., is disclosed within U.S. Pat. No. 4,982,625 which issued to Bonner on Jan. 8, 1991. As disclosed within FIG. 2 which corresponds substantially to FIG. 1 of this particular patent, a drilled hole 11 is formed within a concrete foundation member 10, and a breakable capsule 12, containing a suitable chemical adhesive material, is disposed within the bottom of the bore 11. An externally threaded stud or anchor 13 is adapted have its conically shaped or pointed lower end portion 14 inserted within the drilled bore 11, while the upper end portion of the threaded stud or anchor 13 is adapted to be disposed within a driver 18. The lower end portion of the driver 18 is provided with an internally threaded bore 26, and the axially inner end portion of the bore or hole 26 is undercut or radially enlarged as at 27, while the transversely extending end wall of the bore or hole 26 has an axially tapered face 28.

An adaptor 30 is releasably attached to the upper end portion of the driver 18 by means of a transversely oriented retainer pin 38 and is provided for operatively connecting the driver 18 to a rotary drive means, such as, for example, an electric drill, not shown. The adaptor 30 comprises an upper shank portion 31 which is adapted to be disposed within the chuck portion of the drill, and a lower shaft portion 34 which is adapted to be seated within an axial bore 35 formed within the upper body portion 19 of the driver 18. The transversely extending pin 38 extends through a transverse bore 40 formed within the upper body portion 19 of the driver 18, as well as through a transverse bore 39 formed within the adaptor shaft portion 34, and is retained in position by means of an 0-ring 41 disposed within a peripheral groove 42. It is noted that when the upper end portion of the threaded stud or anchor 13 is disposed within the internally threaded bore or hole portion 26 of the driver 18, the axially tapered face 28 comprising the transversely extending end wall of the bore or hole 26 will be disposed in pressed contact with the convexly shaped upper end portion 15 of the threaded stud or anchor 13. It is further noted that the mode of operation of drivingly inserting the threaded stud or anchor 13 within the bore 11 of the foundation 10 is submitted to be readily apparent, and is similar to that previously described in connection with the aforenoted patent to Sadanandan et al., and therefore, a detailed description of the same will be omitted.

While the threaded anchor insertion tool of Bonner admittedly eliminated the need for a plurality of wrenches to be used when the driver 18 is to be separated from the upper end portion of the threaded stud or anchor 13, as was the case with the drive unit or system of Sadanandan et al., it can nevertheless be readily appreciated that the tool or drive system of Bonner still comprises a substantial number of component parts. In addition, when the axially tapered wall portion 28 of the driver 18, which effectively defines the transversely extending end wall of the bore or hole 26 defined within the lower end portion of the driver 18, is engaged or disposed in pressed contact with the convexly shaped upper end portion 15 of the threaded stud or anchor 13, such contact will effectively cause gouging or scarring of the upper end portion 15 of the stud or anchor 13 thereby causing the same to be environmentally exposed which will in turn lead to corrosion of the stud or anchor 13.

A need therefore exists in the art for a new and improved setting tool or drive mechanism, for use in connection with threaded rods, studs, anchors, and the like, which are adapted to be fixedly secured within concrete, masonry, rock, or similar foundations or underlying substrates, which is relatively simple in structure, which has a relatively small number of component parts, and which can properly engage the threaded stud or anchor so as to operatively drive the same without causing scarring or frictional binding of the same.

### OBJECTS OF THE INVENTION

Accordingly, it is an object of the present invention to provide a new and improved setting tool which is to be used in connection with the driving insertion and fixation of adhesively bonded threaded rods, studs, anchors, or the like, within concrete, masonry, rock, or similar foundations or underlying substrates.

Another object of the present invention is to provide a new and improved setting tool which is to be used in connection with the driving insertion and fixation of adhesively bonded threaded rods, studs, anchors, or the like, within concrete, masonry, rock, or similar foundations or underlying substrates, and which effectively overcomes the various operational drawbacks and disadvantages characteristic of PRIOR ART setting tools or driving devices.

An additional object of the present invention is to provide a new and improved setting tool which is to be used in connection with the driving insertion and fixation of adhesively bonded threaded rods, studs, anchors, or the like, within concrete, masonry, rock, or similar foundations or underlying substrates, and which is relatively simple in structure and comprises a small number of component parts.

A further object of the present invention is to provide a new and improved setting tool which is to be used in connection with the driving insertion and fixation of adhesively bonded threaded rods, studs, anchors, or the like, within concrete, masonry, rock, or similar foundations or underlying substrates, and which is able to properly engage the threaded stud or anchor so as to operatively drive the same without causing scarring or frictional binding of the same.

A last object of the present invention is to provide a new and improved setting tool which is to be used in connection with the driving insertion and fixation of adhesively bonded threaded rods, studs, anchors, or the like, within concrete, masonry, rock, or similar foundations or underlying substrates, and which is alternatively capable of being removed from the threaded rod, stud, or anchor fixedly secured within the drilled blind bore pre-formed within the concrete, masonry, rock, or similar foundation or underlying substrate so as to be reuseable in connection with the driving insertion and fixation of other threaded rods, studs, anchors, or the like, within pre-drilled blind bores formed within other concrete, masonry, rock, or similar foundations or underlying substrates, or which is capable of being separated, along a pre-defined line of frangibility, from a nut member portion of the setting tool such that the nut member remaining upon the threaded rod, stud, or anchor is capable of fixing various components to the foundation or underlying substrate.

### SUMMARY OF THE INVENTION

The foregoing and other objectives are achieved in accordance with the teachings and principles of the present invention through the provision of a new and improved setting tool which is to be used in connection with the driving insertion and fixation of adhesively bonded threaded rods, studs, anchors, or the like, within concrete, masonry, rock, or similar foundations or underlying substrates, and which effectively comprises a cap having a cup-shaped configuration. The cup-shaped cap is internally threaded upon the interior peripheral wall portion thereof, and an axially extending button projects into the cup-shaped member from the closed end wall portion thereof for engaging the free end portion of the threaded rod so as to drivingly insert the threaded rod into the blind bore defined within the underlying substrate or foundation. The external periphery of the cup-shaped member has a hexagonal configuration so as to be capable of being driven by means of a hex socket drive, or alternatively, the head portion of the cup-shaped cap member may have a suitable axially extending, geometrically configured socket formed therein for receiving a suitable driving tool having a correspondingly shaped configuration. As a last feature of the present invention, the external peripheral wall portion of the cup-shaped cap member may have an annular recess or notch formed therein so as to effectively provide the peripheral wall portion with predetermined weakened properties along a line of frangibility. Once the threaded rod is fully driven into the blind bore defined within the underlying substrate or foundation by means of the cup-shaped setting tool, further torqued rotation of the setting tool will cause the end wall portion of the setting tool to separate from the remaining peripheral wall portion of the setting tool along the line of frangibility whereby the remaining peripheral wall portion of the setting tool, still threadedly disposed upon the free end portion of the threaded rod, will serve as a nut member to secure various components to the underlying substrate or foundation.

### BRIEF DESCRIPTION OF THE DRAWINGS

Various other objects, features, and attendant advantages of the present invention will be more fully appreciated from the following detailed description when considered in connection with the accompanying drawings in which like reference characters designate like or corresponding parts throughout the several views, and wherein:

FIG. 1 is an elevational view, partly in cross-section, of a first, conventional, PRIOR ART system for driving and setting a threaded rod or anchor within a pre-drilled hole or bore defined within an underlying substrate or foundation;

FIG. 2 is an elevational view, partly in cross-section, of a second, conventional, PRIOR ART system for driving and setting a threaded rod or anchor within a pre-drilled hole or bore defined within an underlying substrate or foundation;

FIG. 3 is a top plan view of a new and improved setting tool constructed in accordance with the principles and teachings of the present invention and showing various structural features thereof;

FIG. 4 is a side elevational view of the new and improved setting tool of the present invention as disclosed within FIG. 3;

FIG. 5 is a bottom plan view of the new and improved setting tool of the present invention as disclosed within FIGS. 3 and 4;

FIG. 6 is a cross-sectional view of the new and improved setting tool of the present invention as disclosed within FIG. 4 and as taken along the lines 6-6 of FIG. 4;

FIG. 7 is an enlarged schematic cross-sectional view, of the new and improved setting tool of the present invention, similar to that of FIG. 6 showing, however, in greater detail of some of the unique features characteristic of the present invention; and

FIG. 8 is a cross-sectional view similar to that of FIG. 7, showing, however, the setting tool separated into first and second discarded and nut members after the setting tool has been effectively been broken along a predetermined line of frangibility.

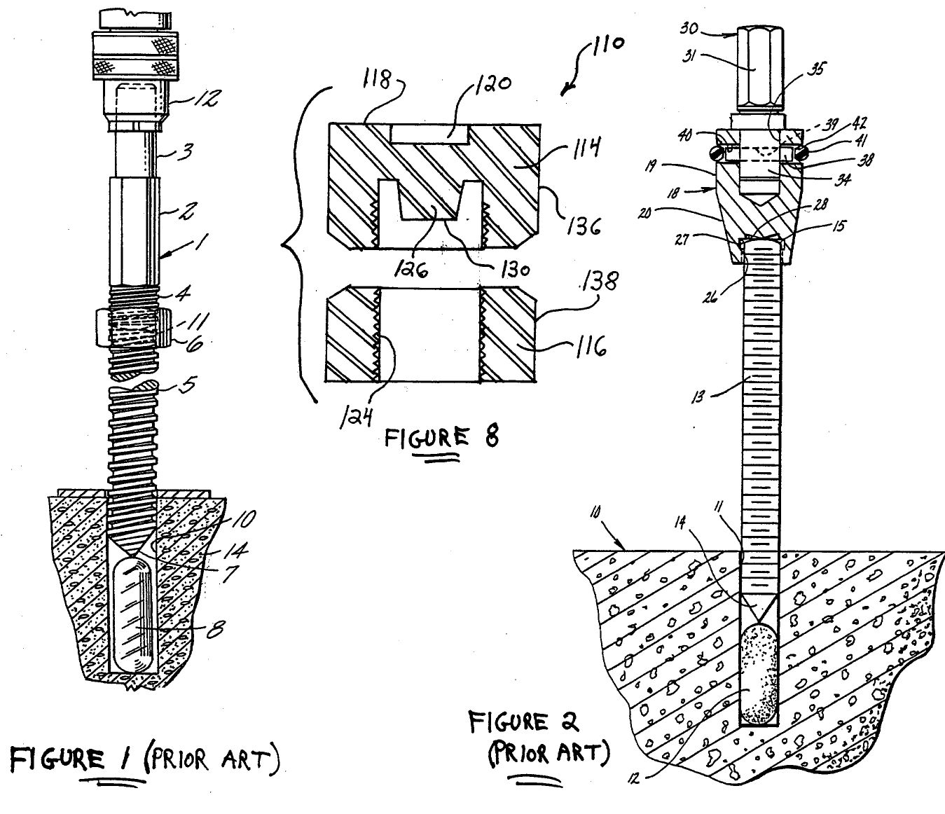

### DETAILED DESCRIPTION OF THE PREFERRED EMBODIMENT

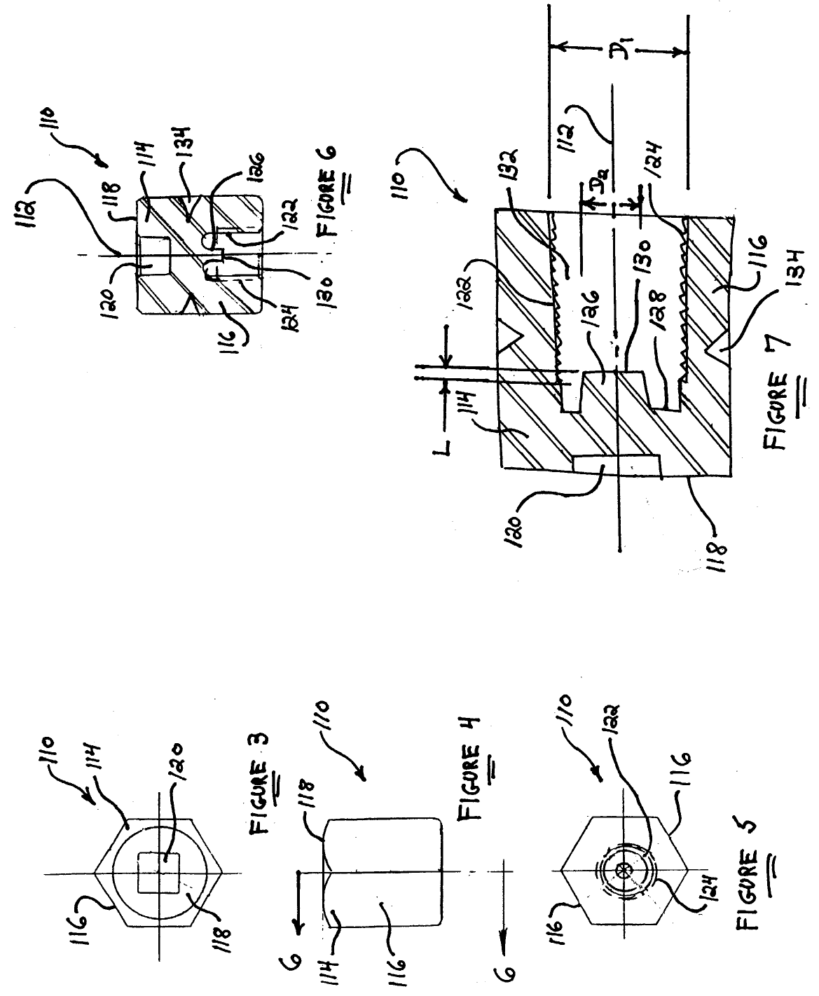

Referring now to the drawings, and more particularly to FIGS. 3-7 thereof, a new and improved setting tool, constructed in accordance with the teachings and principles of the present invention, is disclosed and is generally indicated by the reference character 110. As can readily be seen and appreciated, the new and improved setting tool 110 of the present invention comprises a cap that is adapted to be threadedly mounted upon a free end portion of a threaded rod, anchor, or stud which may have a planar or non-planar surface configuration and which is adapted to be adhesively bonded within a pre-drilled blind bore or hole formed within an underlying substrate or foundation, wherein such substrate or foundation may be formed from a suitable material, such as, for example, rock, masonry, concrete, or the like. As can be readily seen and appreciated further, the new and improved setting tool 110 has a substantially cup-shaped configuration which has a substantially U-shaped cross-sectional configuration symmetrically formed around a longitudinal axis 112, and more particularly, it is seen that the cup-shaped setting tool 110 comprises a transversely extending head section 114 and an axially extending annular wall portion 116 integrally connected to the head section 114. The exterior wall structure of the setting tool 110 has a substantially hexagonal or similar geometrical configuration so as to permit the setting tool 110 to be inserted within a correspondingly configured socket portion of a suitable rotary drive tool, not shown, whereby the setting tool 110 can be rotationally driven thereby, or alternatively, the external end surface 118 of the head section 114 is provided with a recessed socket portion 120 for receiving a suitable rotary drive tool, not shown. While the recessed socket portion 120 is illustrated as having a substantially square-shaped con-figuration, the recessed socket portion 120 can have other geometrical configurations which likewise enable the setting tool 110 to be rotatably driven by means of a suitable rotary drive tool, not shown.

In accordance with a first unique structural feature or characteristic of the present invention, as can best be appreciated from FIGS. 6 and 7, a button member 126, having a substantially circular cross-sectional configuration, is integrally formed upon an interior end wall portion 128 of the head section 114 of the setting tool 110 so as to project axially inwardly within the setting tool 110 and thereby extend toward the open end of the setting tool 110. The internal peripheral wall portion 122 of the axially extending annular wall portion 116 is threaded as at 124 so as to permit the setting tool 110 to be threadedly engaged upon a free end portion of a threaded rod, stud, or anchor, as has been illustrated, for example, in FIG. 2, and when the setting tool 110 is in fact threadedly engaged upon the free end portion of the threaded rod, stud, or anchor, the free end surface portion 130 of the button member 126, which extends transversely with respect to the longitudinal axis 112 of the setting tool 110, is adapted to engage the free end portion of the threaded rod, stud, or anchor. It is noted that the free end surface portion 130 of the button member 126 is substantially planar, and in this manner, when the setting tool 110 is threadedly secured upon the free end portion of the threaded rod, anchor, or stud, which is to be fixedly adhesively bonded within a pre-drilled blind bore or hole formed within an underlying substrate or foundation, the driving loads transmitted by the button member 126, and the free end portion 130 thereof, to the free end portion of the threaded rod, anchor, or stud, will be substantially uniformly distributed over the surface area of the free end portion 130 of the button member 126 so as not to tend to mar, scar, gouge, or otherwise deleteriously affect the free end portion of the threaded rod, anchor, or stud. In this manner, unlike, for example, the structural arrangement of the driver 18 and the threaded rod or anchor 13 of the aforenoted patented system of Bonner, the structure of the button member 126 does not tend to mar, scar, or gouge the free end portion of the threaded rod, anchor, or stud so as not to in turn cause any corrosion or other structural deterioration of the threaded rod, anchor, or stud as a result of the coating layers thereof being otherwise exposed to environmental conditions.

Continuing further, it is also to be appreciated that the annular wall portion 116 of the setting tool 110 has a predetermined internal diametrical extent comprising a predetermined dimension D₁, and in a similar manner, the free end portion 130 of the button member 126 is likewise provided with a predetermined diametrical extent comprising a predetermined dimension D₂ which is substantially less than that of the predetermined diametrical extent dimension D₁ of annular wall portion 116. In particular, the predetermined diametrical extent dimension D₂ of the free end portion 130 of the button member 126 may be within a range of, for example, approximately twenty-five to fifty percent (25-50%) of the predetermined internal diametrical extent dimension D₁ characterizing the annular wall portion 116. In this manner, as has been noted hereinbefore, the planar surface defined by the free end portion 130 of the button member 126, and the diametrical extent thereof, is large enough so as to substantially uniformly distribute and apply the driving forces of the setting tool 110 to the free end portion of the threaded rod or anchor without in effect concentrating such forces along a point or linear contact locus so as not to deleteriously affect the free end portion of the threaded rod or anchor.

Still further, and conversely, the diametrical extent of the planar surface defined by means of the free end portion 130 of the button member 126 is small enough so as not to create or generate excessive frictional or binding forces, which are a function of surface area, between the free end portion 130 of the button member 126 and the free end portion of the threaded rod or anchor when the free end portion 130 of the button member 126 is engaged with the free end portion of the threaded anchor or rod during installation of the threaded anchor or rod within the pre-drilled bore or hole provided within the underlying foundation or substrate. If the surface area of the free end portion 130 of the button member 126 is too large so as to generate or create excessive frictional or binding forces, such forces will tend to effectively prevent the ready disengagement of the setting tool 110 from the free end portion of the threaded anchor or rod after the latter has been fully disposed within the pre-drilled bore or hole defined within the underlying substrate or foundation, which is obviously undesirable. It is also noted, in connection with the provision of the threads 124 upon the internally threaded wall portion of the setting tool 110, that the axial extent or length of the internal threaded portion 124, as such extends from the open end 134 of the setting tool 110 to the interior end wall portion 128 of the setting tool 110, is less than the axial extent of the annular wall portion 116.

Still further, it is additionally noted, in connection with the button member 126, and its disposition within the internal space 132 of the setting tool 110, that the button member 126 has a predetermined axial extent such that the free end portion 130 of the button member 126 is disposed at an axial position which is axially beyond the end of the threaded portion 124 which is disposed adjacent to or within the vicinity of the interior end wall portion 128 of the setting tool 110 as disclosed at L in FIGS. 6 and 7. The reason for this interrelated structure is that the free end portion 130 of the button member 126 will necessarily engage the free end portion of the threaded rod or anchor prior to the termination of the threaded engagement of the threaded rod or anchor with the end threads of the threaded portion 124 which are disposed adjacent to or within the vicinity of the interior end wall portion 128 of the setting tool 110. Considered from an opposite point of view, the free end portion of the threaded rod or anchor can never effectively extend beyond the end threads of the threaded portion 124 which are disposed adjacent to or within the vicinity of the interior end wall portion 128 of the setting tool 110, otherwise such end threads might effectively cut or tap new threads into the interior peripheral side wall portion of the setting tool 110 which would likewise leading to the creation of additional frictional or binding forces. In particular, the dimension L, which defines the axial dimension that the free end portion of the button member 126 extends beyond the interior end of the threads 124 may comprise, for example, an axial extent equivalent to two times the pitch distance defined between successive threads.

After the setting tool 110 has been utilized for driving a threaded rod or anchor into a pre-drilled hole or bore formed within an underlying foundation or substrate, and within which a suitable adhesive bonding material capsule is disposed for fixedly bonding the threaded rod or anchor within the underlying foundation or substrate when the adhesive capsule is punctured by the threaded rod or anchor, the entire setting tool 110 can be threadedly disengaged from the free end portion of the threaded rod or anchor so as to again be used as a setting tool in connection with the insertion of additional threaded anchors or rods within the same or other underlying substrates or foundations. Alternatively, a final unique feature of the present invention comprises structure integrally incorporated within the setting tool 110 which enables the same to effectively be separated into two parts wherein a first end portion of the setting tool 110 is removed from the threaded anchor or rod while a second nut portion remains threadedly engaged upon the threaded rod or anchor so as to be subsequently utilized in connection with securing auxiliary components to the underlying foundation or substrate.

More particularly, with reference lastly being made to FIGS. 6-8, an annular V-shaped notch or groove 134 is formed within the outer peripheral surface of the annular wall portion 116 at an axial position which is substantially intermediate the opposite ends of the setting tool 110. The V-shaped notch or groove 134 therefore defines an annular line of frangibility along which the setting tool 110 can effectively be separated into a first residual member or piece 136 which contains the head section 114 and which is adapted to be threadedly disengaged from the threaded rod or anchor so as to be subsequently discarded, and a second member or piece 138 which comprises a nut member and which is adapted to remain threadedly engaged upon the threaded rod or anchor so as to secure auxiliary components to or upon the underlying foundation or substrate. The setting tool 110 may be readily fabricated from any one of a plurality of materials, such as, for example, glass-filled NYLON®, and it is noted that the radially inward depth to which the annular groove or notch 134 is formed will affect the relative torque-resistant strength properties of the setting tool 110. If the radial depth of the annular groove or notch 134 is relatively shallow, then the setting tool 110 will exhibit relatively high torque resistant properties within the vicinity of the annular groove or notch 134 and along the line of frangibility thereof, while conversely, if the radial depth of the annular groove or notch 134 is relatively deep, then the setting tool 110 will exhibit relatively low torque-resistant properties within the vicinity of the annular groove or notch 134 and along the line of frangibility thereof. It can therefore be appreciated further that the depth of the annular groove or notch 134 effectively determines the torque limit at which the first residual and second nut members 136,138 can be separated from each other. A desired torque limit at which the first and second pieces will be separated from each other may be, for example, two hundred fifty (250) foot-pounds of torque.

In order to achieve such torque limit and the separation of the setting tool 110 into the first and second residual and nut members 136,138, the setting tool 110 can initially be retained upon the free end portion of the threaded rod or anchor until the adhesive material, disposed within the pre-drilled bore or hole of the underlying foundation or substrate, cures and sets, whereupon a predetermined amount of rotational torque can be applied to the setting tool 110. Since the setting tool 110 cannot be threaded any further onto the free end portion of the threaded rod or anchor due to the previously established engaged contact defined between the button member 126 of the setting tool 110 and the free end portion of the threaded anchor or rod, the rotational torque applied to the setting tool 110 will cause the setting tool 110 to fracture, along the line of frangibility as defined by means of the annular groove or notch 134, so as to separate into the first residual and second nut members 136,138. Alternatively, if it is desired to separate the setting tool 110 into its residual and nut members 136,138 prior to the curing and setting of the adhesive material disposed within the pre-drilled bore or hole of the underlying foundation or substrate, a pair of wrenches or similar tools can be utilized to grasp the upper and lower end portions of the setting tool 110 whereupon relative torque rotation of the tools in opposite directions will cause the setting tool 110 to be separated into its residual and nut members components 136,138.

Thus, it may be seen that in accordance with the teachings and principles of the present invention, there has been disclosed a new and improved setting tool, for use in connection with the insertion of threaded rods, anchors, or studs within holes or bores pre-drilled within an underlying substrate or foundation, wherein a button member, having a planar end surface, engages the free end portion of the threaded rod or anchor so as to uniformly distribute the driving forces thereto without causing any gouging or scarring of the same. In addition, the external side wall portion is provided with an annular notch or groove which provides the setting tool with predetermined torque-resistant properties. When the torque limit is desirably exceeded, the setting tool is able to be separated into a residual member which may be discarded, and a nut member which may be retained upon the threaded rod or anchor so as to be capable of securing auxiliary components to the underlying foundation or substrate.

Obviously, many variations and modifications of the present invention are possible in light of the above teachings. It is therefore to be understood that within the scope of the appended claims, the present invention may be practiced otherwise than as specifically described herein.

What is claimed as new and desired to be protected by Letters Patent of the United States of America, is:

1. A setting tool for use in connection with the insertion and fixation of threaded rod anchors within bores preformed within a substrate, comprising:
a substantially cup-shaped housing defining an axis around which said substantially cup-shaped housing is capable of being rotated;
means defined upon an external portion of a first end of said substantially cup-shaped housing for operative interaction with a rotary drive tool such that when the rotary drive tool is rotated, said substantially cup-shaped housing will be rotated around said axis;
an internally threaded bore extending axially inwardly from a second end of said substantially cup-shaped housing and adapted to threadedly engage a threaded rod anchor when an end portion of the threaded rod anchor is axially inserted into said internally threaded bore; and
a button member extending axially inwardly from an internal portion of said first end of said substantially cup-shaped housing and having a substantially planar surface portion for engaging the end portion of the threaded rod anchor when the threaded rod anchor is inserted into and threadedly engaged within said internally threaded bore of said substantially cup-shaped housing such that said button member can substantially uniformly transmit driving forces toward the threaded rod anchor without adversely affecting the structural integrity of the end portion of the threaded rod anchor.

2. The setting tool as set forth in claim 1, wherein:
the external periphery of said first end of said substantially cup-shaped housing has a predetermined cross-sectional geometrical configuration for defining a drive means operatively interactive with the rotary drive tool.

3. The setting tool as set forth in claim 2, wherein:
said predetermined cross-sectional geometrical configuration of said external periphery of said first end of said substantially cup-shaped housing comprises that of a hexagon.

4. The setting tool as set forth in claim 1, wherein:
said first end of said substantially cup-shaped housing has a geometrically configured socket portion for defining a drive means operatively interactive with the rotary drive tool.

5. The setting tool as set forth in claim 1, wherein:
said internally threaded bore defined within said substantially cup-shaped housing has a first predetermined diametrical extent; and
said substantially planar surface of said button member has a second diametrical extent which is only a fractional proportion of said first predetermined diametrical extent of said internally threaded bore defined within said substantially cup-shaped housing.

6. The setting tool as set forth in claim 5, wherein:
said fractional proportion of said second diametrical extent of said substantially planar surface of said button with respect to said first predetermined diametrical extent of said internally threaded bore defined within said substantially cup-shaped housing is within the range of approximately 25-50% so as not to generate excessive frictional forces between said substantially planar surface of said button member and the end portion of the threaded rod anchor.

7. The setting tool as set forth in claim 1, wherein:
said button member has a first predetermined axial extent extending axially inwardly from said first end of said substantially cup-shaped housing, and said internally threaded bore has a second predetermined axial extent extending axially inwardly from said second end of said substantially cup-shaped housing, whereby said first and second axial extents axially overlap each other by a predetermined amount such that said substantially planar surface portion of said button member is disposed at an axial position which is axially beyond the internal end of said threaded bore whereby said button member will engage the end portion of the threaded rod anchor prior to the end portion of the threaded rod anchor reaching the internal end of said threaded bore such that the end portion of the threaded rod anchor is effectively prevented from tapping additional threads internally within said substantially cup-shaped housing.

8. The setting tool as set forth in claim 7, wherein:
said predetermined amount by which said button member and said internally threaded bore axially overlap each other comprises a distance approximately equal to twice the pitch of the threads defining said internally threaded bore.

9. The setting tool as set forth in claim 1, further comprising:
an annular notch defined within an external peripheral portion of said substantially cup-shaped housing for defining a line of frangibility along which said substantially cup-shaped housing can be divided into a residual component to be discarded after the threaded anchor has been fixed within a substrate, and a nut component, threadedly engaged upon the threaded rod anchor, for securing auxiliary components to the substrate.

10. In combination, a rotary drive tool, and a setting tool for use in connection with the insertion and fixation of threaded rod anchors within bores preformed within a substrate, comprising:
a rotary drive tool; and
a setting tool operatively engageable with said rotary drive tool for use in connection with the insertion and fixation of threaded rod anchors within bores preformed within a substrate,
said setting tool comprising a substantially cup-shaped housing defining an axis around which said substantially cup-shaped housing is capable of being rotated; means defined upon an external portion of a first end of said substantially cup-shaped housing for operative interaction with said rotary drive tool such that when said rotary drive tool is rotated, said substantially cup-shaped housing will be rotated around said axis; an internally threaded bore extending axially inwardly from a second end of said substantially cup-shaped housing and adapted to threadedly engage a threaded rod anchor when an end portion of the threaded rod anchor is axially inserted into said internally threaded bore; and a button member extending axially inwardly from an internal portion of said first end of said substantially cup-shaped housing and having a substantially planar surface portion for engaging the end portion of the threaded rod anchor when the threaded rod anchor is inserted into and threadedly engaged within said internally threaded bore of said substantially cup-shaped housing such that said button member can substantially uniformly transmit driving forces toward the threaded rod anchor without adversely affecting the structural integrity of the end portion of the threaded rod anchor.

11. The combination as set forth in claim 10, wherein:
the external periphery of said first end of said substantially cup-shaped housing has a predetermined cross-sectional geometrical configuration for defining a drive means operatively interactive with the rotary drive tool.

12. The combination as set forth in claim 11, wherein:
said predetermined cross-sectional geometrical configuration of said external periphery of said first end of said substantially cup-shaped housing comprises that of a hexagon.

13. The combination as set forth in claim 10, wherein:
said first end of said substantially cup-shaped housing has a geometrically configured socket portion for defining a drive means operatively interactive with said rotary drive tool.

14. The combination as set forth in claim 10, wherein:
said internally threaded bore defined within said substantially cup-shaped housing has a first predetermined diametrical extent; and
said substantially planar surface of said button member has a second diametrical extent which is only a fractional proportion of said first predetermined diametrical extent of said internally threaded bore defined within said substantially cup-shaped housing.

15. The combination as set forth in claim 14, wherein:
said fractional proportion of said second diametrical extent of said substantially planar surface of said button with respect to said first predetermined diametrical extent of said internally threaded bore defined within said substantially cup-shaped housing is within the range of approximately 25-50% so as not to generate excessive frictional forces between said substantially planar surface of said button member and the end portion of the threaded rod anchor.

16. The combination as set forth in claim 10, wherein:
said button member has a first predetermined axial extent extending axially inwardly from said first end of said substantially cup-shaped housing, and said internally threaded bore has a second predetermined axial extent extending axially inwardly from said second end of said substantially cup-shaped housing, whereby said first and second axial extents axially overlap each other by a predetermined amount such that said substantially planar surface portion of said button member is disposed at an axial position which is axially beyond the internal end of said threaded bore whereby said button member will engage the end portion of the threaded rod anchor prior to the end portion of the threaded rod anchor reaching the internal end of said threaded bore such that the end portion of the threaded rod anchor is effectively prevented from tapping additional threads internally within said substantially cup-shaped housing.

17. The combination as set forth in claim 16, wherein:
said predetermined amount by which said button member and said internally threaded bore axially overlap each other comprises a distance approximately equal to twice the pitch of the threads defining said internally threaded bore.

18. The combination as set forth in claim 10, further comprising:
an annular notch defined within an external peripheral portion of said substantially cup-shaped housing for defining a line of frangibility along which said substantially cup-shaped housing can be divided into a residual component to be discarded after the threaded anchor has been fixed within a substrate, and a nut component, threadedly engaged upon the threaded rod anchor, for securing auxiliary components to the substrate.
